(19) United States
(12) Patent Application Publication
(10) Pub. No.: US 2002/0188466 A1
(43) Pub. Date: Dec. 12, 2002

(54) Secure digital medical intellectual property (IP) distribution, market applications, and mobile devices

(76) Inventors: Pierre Philip Barrette, Murphysboro, IL (US); Michael Saigh, DuQuoin, IL (US); Nancy J. Bishop, Carbondale, IL (US)

Correspondence Address: Caroline G Chicoine, Thompson Coburn LLP, One Firstar Plaza, St. Louis, MO, 63101, US

(21) Appl. No.: 09/837,112

(22) Filed: Apr. 18, 2001

(51) Int. Cl. G06F 17/60

(52) U.S. Cl. 705/2; 705/3

(57) ABSTRACT

One embodiment of the present invention is a hand-held mobile field device configured to provide wireless communication with a plurality of patient medical monitoring devices. Another embodiment of the present invention is a network including at least one hand-held mobile field device of the type described above, the network also being electronically connected to databases maintained by a hospital.

### BACKGROUND OF THE INVENTION

The invention relates to methods and apparatus to securely distribute and transfer medical records, pharmaceutical orders, stationary assessment and other information that integrate information from a variety of medical sources including patient diagnosis into a mobile environment.

Computerization of patient accounts and patient medical record information is known. This computerization process is an arduous process of logging records and compiling nursing station patient information with doctors' diagnoses. In known computerized networks, reference materials, textbooks and medical library materials are not disseminated through a digitally secure network nor vertically integrated with other medical IP such as ICU records, etc.

In addition to computerized networks, a centralized digital pharmaceutical order processing technology exists that links doctors, nurses, other health care professionals, pharmacies, and patients. This technology integrates controlled access of drug inventory supplies, physicians' prescriptions, secure access, patient account processing, online purchase of pharmaceutical supplies and prescriptions, accounting and billing. A software program running on a hand-held device permits a physician to browse through a database of prescription dosages and to acquire drug information that is currently in a reference text, including information about drug interactions. Prescriptions are transmitted via a wireless device to a server, which sends prescription information through a secure network to a pharmacy, eliminating many opportunities for error. Medical information databases accessible via PDA (personal digital assistant) devices such as those available from Palm, Compaq and iScribe are being developed. However, this online access is of limited usefulness because it is not integrated with the pharmaceutical process to overall secure medical IP dissemination.

It would thus be desirable to provide more secure methods and apparatus for secure distribution of medical IP, including stationary and fixed monitoring of patient assessment data. It would also be desirable to digitally consolidate data for the benefit of users as opposed to obtaining small amounts of information on various databases that are not presently compatible.

Currently, medical information and materials are disseminated either in abstract form or in full text. However, publishers would like to prevent unauthorized distribution of copyrighted texts to obtain value in return for their texts. Thus, it would be desirable to provide methods and apparatus to enable medical organizations and personnel, including medical and nursing students, to obtain complete content such as reference materials, textbooks and other trade research IP while guarding copyright and ownership revenue rights.

### BRIEF SUMMARY OF THE INVENTION

There is therefore provided, in one embodiment of the present invention, a hand-held mobile field device configured to provide wireless communication with a plurality of patient medical monitoring devices.

In another embodiment of the present invention, a network including at least one hand-held mobile field device of the type described above, the network also being electronically connected to databases maintained by a hospital.

In yet another embodiment of the present invention, a data monitoring manager (DMM) is used provide a network and wireless communication system with a plurality of patient medical monitoring devices.

Yet another embodiment of the present invention is a network including at least one DMM of the type described above, and electronically communicating with databases maintained by a hospital.

In yet another embodiment of the present invention, a DMM is programmable by an authenticated user to initiate a transfer verification process used during the assessment of patient monitoring.

In still another embodiment of the present invention, a medical data monitoring system (MDMS) is configured to interface a network to databases maintained by a hospital.

In yet another embodiment of the present invention, a DMM is capable of tracking patients and medical staff wearing an identification bracelet or ID badge that contains a microchip.

Some embodiments of the present invention provide solutions for secure distribution of medical IP through coordination of mobile systems with stationary and fixed monitoring of patient assessment data, and/or digitally consolidate data for the benefit of the user.

In addition, some embodiments of the present invention provide methods and apparatus to enable medical organizations and personnel, including medical and nursing students, to obtain complete content such as reference materials, textbooks and other trade research IP while guarding copyright and ownership revenue rights.

### BRIEF DESCRIPTION OF THE DRAWINGS

FIG. 1 is a simplified pictorial diagram of an embodiment of the present invention showing an exemplary IP distribution system that employs a plurality of data monitoring managers (DMMs) in a network having a secure medical data monitoring system (MDMS).

FIG. 2 is a simplified pictorial diagram showing an exemplary interconnection of one embodiment of the portable communicator of FIG. 1 with a plurality of medical devices.

FIG. 3 is a simplified pictorial diagram showing an exemplary interconnection of one embodiment of a data monitoring manager (DMM) with various medical stationary accessories.

FIG. 4 is a simplified pictorial diagram showing an exemplary medical IP patient monitoring network configuration with secure access.

FIG. 5 is a simplified block diagram illustrating an exemplary access control protocol for DMM controller software to control the network of FIG. 5.

FIG. 6 is a simplified pictorial diagram of an exemplary embodiment of a medical IP patient monitoring network illustrating the tracking of patients or medical staff members having an identification bracelet or ID badge containing a microchip.

### DETAILED DESCRIPTION OF THE INVENTION

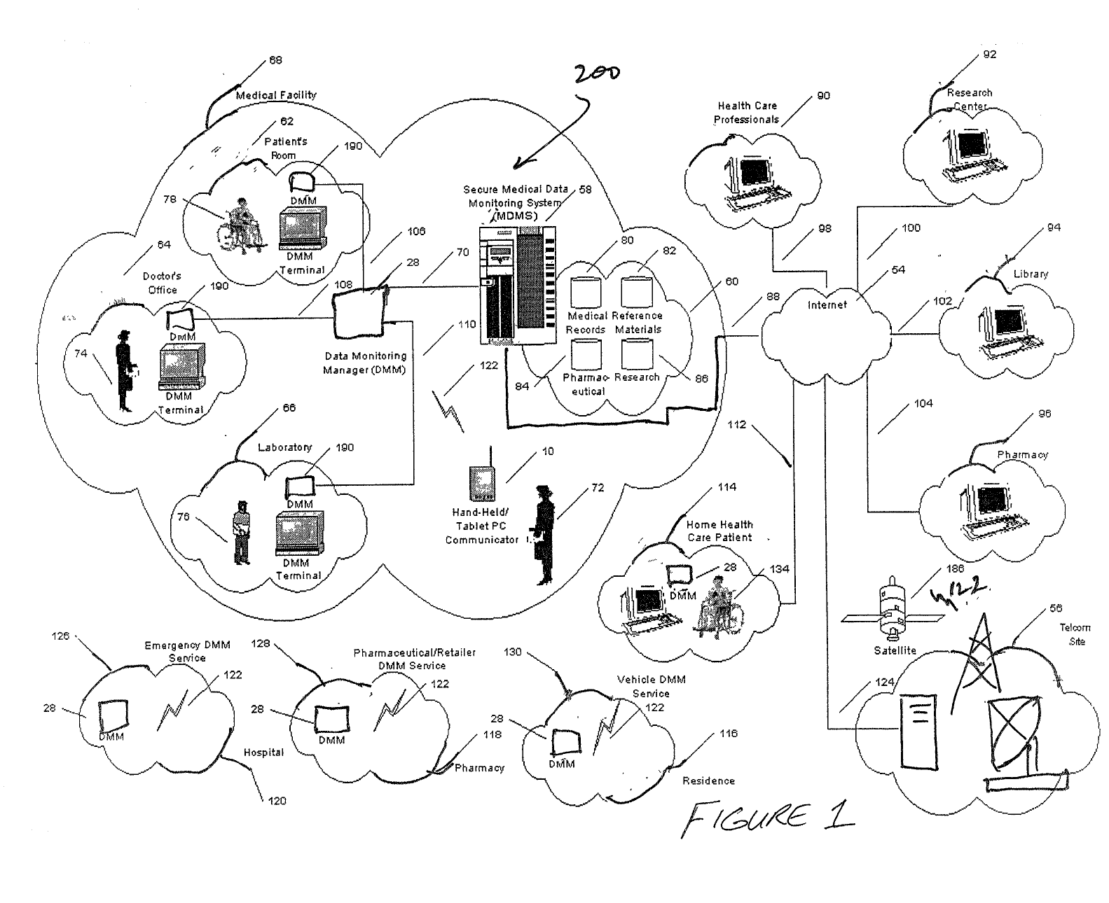

In one exemplary embodiment and referring FIG. 1, a complete secure IP distribution system 200 is provided. This exemplary embodiment includes a secure medical data monitoring system (MDMS) 58 that provides collective consolidated input by users such as physicians 74, health care professionals 72, lab technicians 76, and medical patients 78 and 134. Input is provided by these individuals via data monitoring manager (DMM)/terminal combinations 190 (hereinafter, DMM combinations 190) or handheld terminals 10. This input is communicated via either wired communication links 108, 110, 106, 112 or wireless communication links 122, to MDMS 58. For example, in one embodiment, wired links 106, 108, 110 and wireless link 122 within a medical facility 68 are provided for communication to a DMM 28 that services MDMS 58 via a communication link 70. Communication link 106 is provided for a DMM combination 190 located in a patient's room 62, communication link 108 is provided for a DMM combination 190 located in a doctor's office 64, and communication link 110 is provided for a DMM combination 190 located in a laboratory 66. Communication link 112 is an Internet connection from a DMM combination 190 installed in a home 114 of patient 134, and provides connectivity through a suitable communication network 54 such as the Internet to MDMS 58, which also communicates 88 with network 54.

Collective consolidated input from the various sources is directed by MDMS 58 to one or a combination of information databases in electronic medical library database 60. For example, the input is sent to one or more administrative information databases or patient account records, shown in FIG. 1 collectively as medical records 80 These records can be made available by MDMS 58 to authorized users. For example, authorized records can be accessed via terminals available to outside health care professionals 90, research centers 92, medical libraries 94, pharmacies 96, and via DMMs 28 provided to emergency DMM services 128 at hospitals 120, pharmaceutical/retailer DMM service 122 at pharmacies 118, and vehicle DMM services 130 at residences 116. As shown in FIG. 1, some of these services are provided via wireless links 122 or via the internet 64 through an appropriate network connection 98, 100, 102, 104. Connection can also be established via a telecom carrier 56, which may also provide access 124 to (or from) the Internet 54 or even via satellite 186. In one embodiment of the present invention, each IP data transfer within medical facility 68 from locations 62, 64, and 66 to MDMS 58 occurs via a secure DMM 28 (i.e., secure hardware, for example, communication hardware programmed using firmware or software) that tags IP transmissions and retrievals, and/or the transfer is encrypted using encryption software. In one embodiment, IP distribution system 200 uses at least a subset of the security and IP protection methods and apparatus described in one or more of U.S. Pat. No. 5,734,891, entitled “Electronic communication and storage of time-encoded information,” issued Mar. 31, 1998 to M. Saigh, U.S. Pat. No. 5,734,823, entitled “Systems and apparatus for electronic communication and storage of information,” issued Mar. 31, 1998 to M. Saigh et al., and U.S. patent application Ser. No. 09/511,537, by M. Saigh et al., filed Mar. 23, 2000, each of which are hereby incorporated by reference in their entirety. Payment flow information is linked between diagnostic related groups' (DRG) patient hospital charges and third party insurance providers such as HMOs, PPOs, Medicare, Medicaid and self payers through a chain of IP transfers.

Let us consider one exemplary use of network 200 in a hospital setting. Information concerning patient 78 is secured (for example, via encryption) and electronically transferred via data link 108, which is, for example, a local area network (LAN) or a wireless network. Pharmaceutical orders 96, new medical research 92 and other information is also disseminated or made available to a restricted group of individuals via network 200. Communication units (i.e., hand-held terminals) 10 are restricted in communication of data to network 200. Only those properly identified to MDMS 58 are permitted to transfer data to or from network 200. For example, a personal serial number contained within terminal 10 is used together with biometric security (e.g., a finger- or thumbprint) is used to identify a hand-held terminal 10 to MDMS 58. Thus, information can be restricted to be available only to a selected number of individuals and their terminal devices 10, as necessary. Such embodiments of network 200 are of particular use for transmission and further processing of mobile wireless or non-wireless physician prescriptions, pharmaceutical order processing, prescription and non-prescription dosage tracking, and nurse to patient interface and administration.

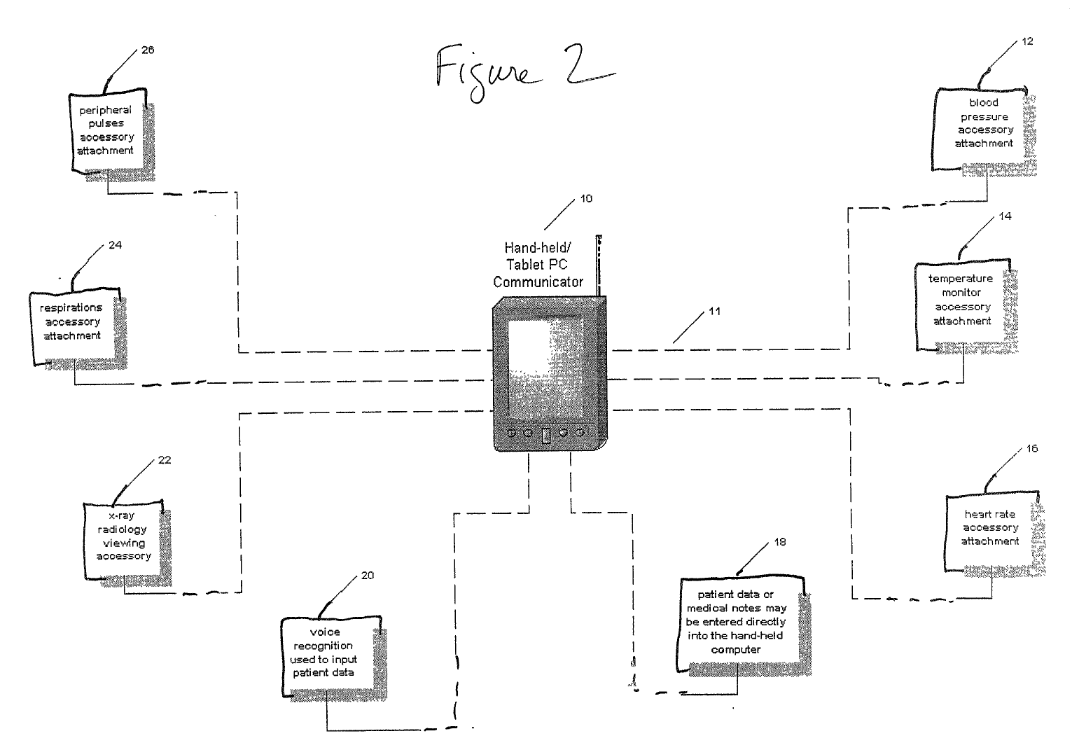

In one embodiment and referring to FIG. 2, a PC communicator (also called a portable terminal or mobile field unit) 10 is a wireless hand-held or tablet-based computer processing device that is portable and optimized for the medical industry. The portability feature of PC communicator 10 allows healthcare professionals to measure, monitor, or access patient medical vital statistics from a remote location. Medical mobile hardware device drivers (not shown) are installed on or in PC communicator 10 and in various medical devices as medical device accessory attachments. Exemplary accessory attachments in one embodiment of the present invention include blood pressure accessory attachment 12, temperature monitor accessory attachment 14, heart rate accessory attachment 16, x-ray radiology viewing accessory 22, respirations accessory attachment 24, and peripheral pulses accessory attachment 26. In one embodiment, accessory attachments used to measure patient critical vital signs are plug-in devices that attach to PC communicator 10, which may be similar to the familiar communication cradle used with PALM™ handheld personal digital assistant (PDA) devices. In another embodiment, PC communicator 10 and accessory attachments such as accessory attachments 12, 14, 16, 22, 24, and 26 are Bluetooth enabled, and communicate wirelessly.

In one embodiment, PC communicator 10 is provided with a touch-sensitive screen 18 or other pressure-sensitive input device for direct entry of patient data or medical notes. Also in one embodiment, voice recognition is provided for direct input via a voice-recognition unit 20, provided internally to communicator 10 or as an external accessory.

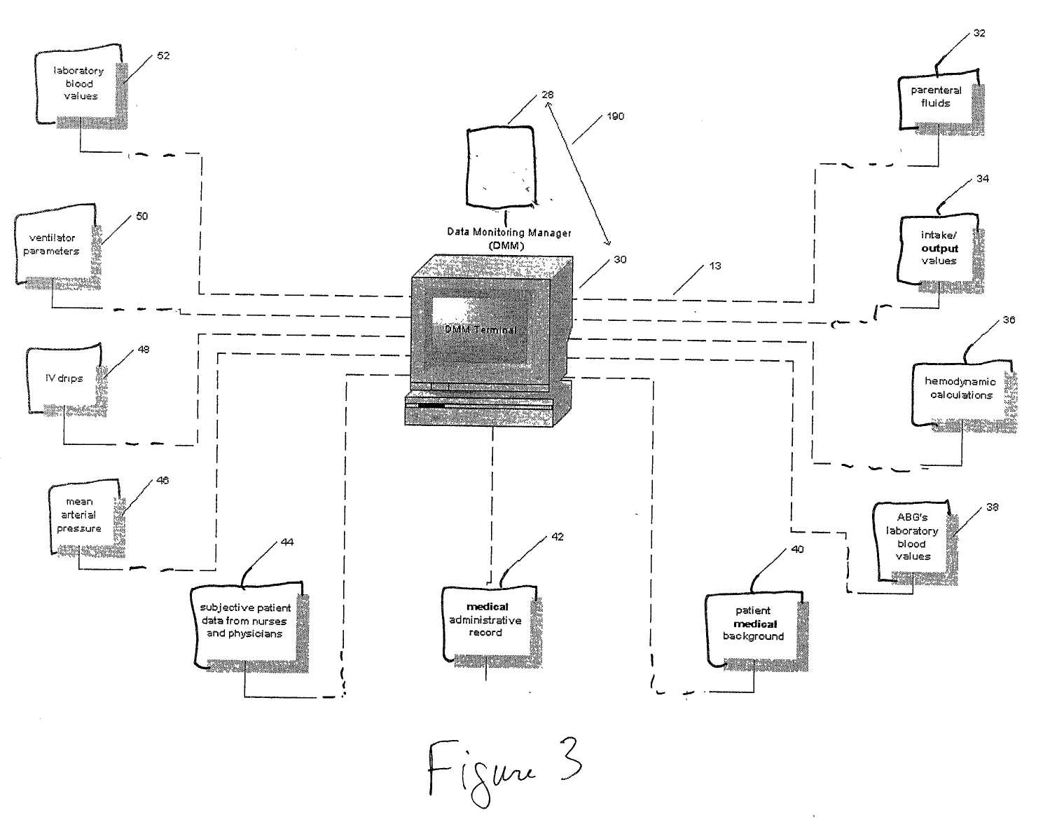

In one embodiment and referring to FIG. 3, data monitoring manager (DMM) 28 provides functionality similar to PC communicator 10 described above. Wireless communication is provided between a collection of different devices, including fixed (i.e., stationary input) units and continuous monitoring systems in patient rooms. Bluetooth interfaces 13 in one embodiment provide wireless communication between medical stationary hardware devices, input devices, databases and sensors for items such as such as parenteral fluids 32, intake/output values 34, hemodynamic calculations 36, ABG's laboratory blood values 38, patient medical background records 40, medical administration records 42, subjective patient data from nurses and physicians 44, mean arterial pressure 46, IV drips 48, ventilator parameters 50, and laboratory blood values 52. In another embodiment, plug-in interfaces are used. Also in one embodiment, a DMM terminal 30 is optionally provided for display and input capabilities. DMM 28 and DMM terminal 30 together form a “DMM combination” 190. DMMs 28 are networked throughout a medical facility 68 such as that shown in FIG. 1 to electronically communicate medical data to a hospital central database 60. In one embodiment, data received by or requested from DMM 28 by a PC communicator 10 (e.g., subjective patient data 44 shown in FIG. 3) is automatically synchronized with the central database 60. This synchronization guarantees that central database 60 contains the most up-to-date information, and that medical personnel can view the most recent and complete information available.

Referring to both FIGS. 2 and 3, medical mobile and stationary hardware devices may be used in various ways, depending upon functionality and monitoring needs of the patient. Hemodynamic calculations incorporate subcategories such as core temperature and oxygen saturation (continuous or stationary input), cardiac output, cardiac index, and peripheral and systematic vascular resistance. Exemplary types of stationary manual monitoring performed by nursing personnel are subjective observations or quantitative or qualitative statistical analysis. Exemplary types of mobile manual inputs are radial pulses and pedal pulses, for which a nurse takes a mobile field unit and manually inputs patient assessments. In addition, x-ray radiologists can view x-rays through a viewing accessory 22. In one embodiment of the present invention, the combination and aggregate of manual, automated, fixed continuous and mobile patient monitoring, and assessments are consolidated and made available. A list of exemplary devices and their categories is provided in Tables 1 and 2.

TABLE 1
Exemplary Mobile Field Hardware Devices

| | Input |
|---|---|
| Device | Category/Categories |
| Temperature monitor accessory attachment 16 | M |
| Heart rate accessory attachment | C, MM |
| X-ray radiology viewing accessory | M, MM |
| Blood pressure 18 | SI, M |
| Map-(Mean arterial pressure) | C |
| Respirations 18 | SI, M |
| Peripheral pulses | M, MM |
| Hemodynamic calculations | C, SI |
| IV drips 22 | SI |
| intake/output | SM |
| Parenteral fluids | SM |
| Laboratory blood values 22 | SI |
| Ventilator parameters | SM |
| ABG's laboratory blood values 22 | SI |
| Ventilator weaning parameters 22 | SI |
| Subjective patient data from nurses and | SI |
| physicians 20 | |
| Patient medical background 20 | SI |
| Medical administration record 22 | SI |

TABLE 2
Device Types

| Input Category Code | Device Type or Input Category |
|---|---|
| M | Mobile |
| MM | Manual Mobile |
| C | Continuous |
| SM | Stationary Mobile |
| SI | Stationary Data Input |

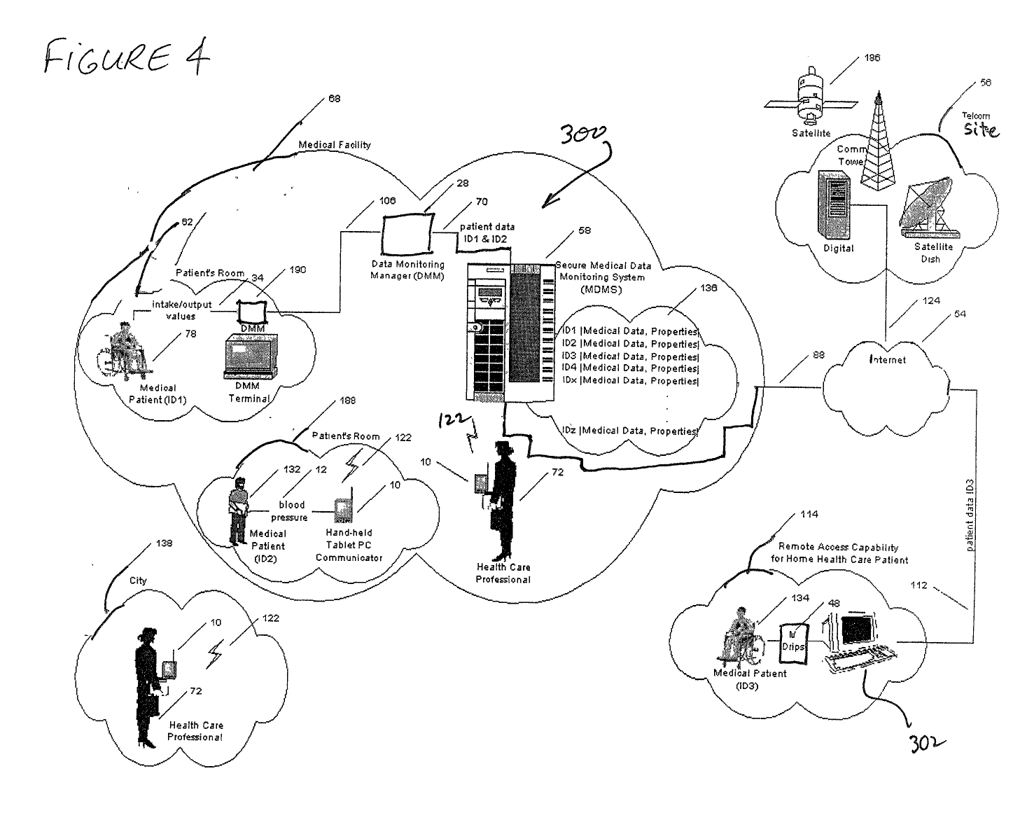

In one embodiment and referring to FIG. 4, medical work in progress is encompassed. Ancillary health professionals are connected to databases maintained by a hospital or medical facility 68 via either wired or wireless links to a network 300 maintained by a hospital. DMMs 28 route data traffic through network 300 to and from MDMS 58. MDMS 58 controls data storage to and retrieval from a database 136 maintained by hospital 68. Various methods are used to store patient medical data in database 136. For example, in one embodiment, a patient 78 located in a room 62 of hospital 68 has intake/output values 34 monitored by DMM combination 190, which transmits this information via a communications link 106 of network 300 to a DMM 28, which relays it via another link 70 to MDMS 58. This data is stored in secure database 136. PC communicator 10 In addition, a PC communicator 10 located in another room 188 of hospital 68 is used to monitor blood pressure 12 of a patient 132, which is communicated to MDMS 58 via a wireless link 122. For example, PC communicator 10 communicates wirelessly 122 with a DMM 28 that relays the communication via network link 70 to MDMS 58. In addition, at a remote health care facility or a home 114, IV drips 48 of yet another patient 134 are monitored and connected via a computer terminal or modem 302 and data link 112 to the Internet or other communication network 54. MDMS 58 receives this data via its own communication link 88 to communication network 54. In one embodiment, data from communication network 54 is received and communicated to MDMS 58 from remote locations via a telecommunications service provider 56, which may provide wireless links 122 via satellite 186. Data from IV drips 48 is encrypted before transmission via link 112 and until it reaches MDMS 58 so that it can be transferred securely via network 54. Data from patient 134 is stored in secure database 136.

Also in one embodiment, a health care professional 72 located at medical facility 68 is able to monitor patent medical data from database 136 wirelessly 122 via DMM 28, which satisfies communication requests from PC communicator 10 via link 70 to MDMS 58. Health care professional 72 is also able to wirelessly monitor patient medical data using PC communicator 10 at locations throughout a city 138 using satellite 186 or communication facility 56. Secure medical data is communicated to and from facility 56 through Internet 54 connection that is communicatively coupled 88 to MDMS 58. Properties specified in database 136 are used (by MDMS 58, for example) to determine which data records of which patients are accessible by health care professional 72.

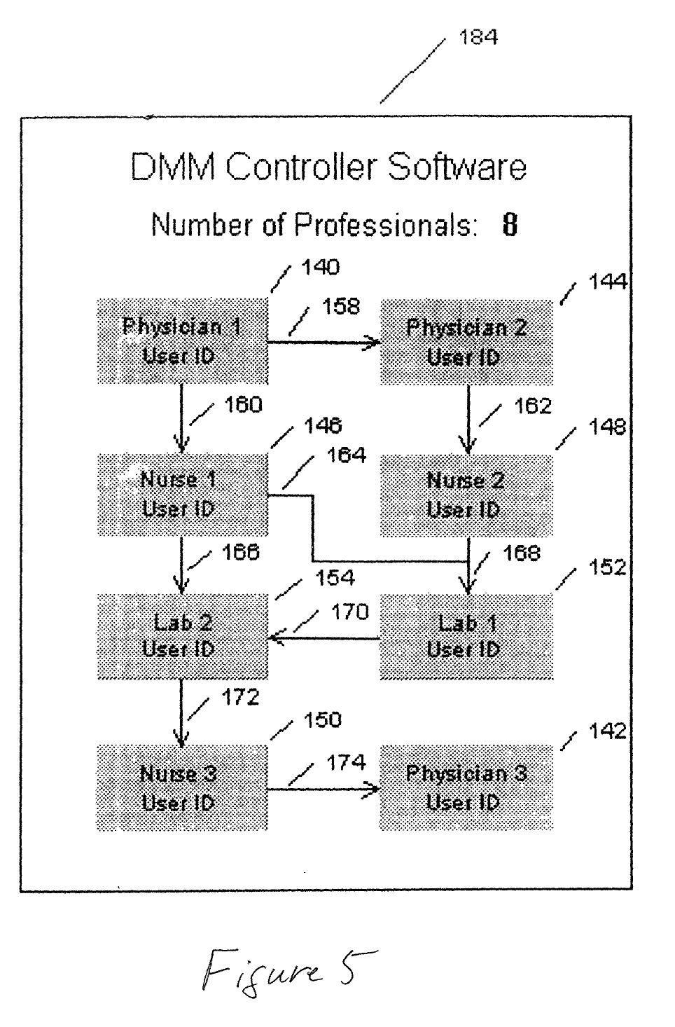

In one embodiment and referring to FIG. 5, payment flow information and data is linked between diagnostic related groups (DRG) patient hospital charges and third party insurance providers such as HMOs, PPOs, Medicare, Medicaid and self-payers. Access to database 136 shown in FIG. 1, for example, is controlled by a DMM 28 connected to MDMS 56 using a transfer verification process designated by a lead physician. For example, a lead physician can specify that information and data concerning a specific patient is accessible for viewing only by one or more predetermined individuals, followed by other predetermined individuals, another medical specialist, and then a nurse, in that order. More particularly, a lead physician (or other authorized individual) configures a transfer verification process exemplified by flow chart 184. Individuals required to submit requested verification do not necessarily have to be located at medical facility 68. In one embodiment, data is biometrically linked to a security combination, such as by using fingerprint recognition technology. If a thumbprint of an individual, for example, does not match in a linear or random parallel or serial sequence of individual thumbprints, that individual is not allowed to open or retrieve a requested document.

FIG. 5 illustrates a configuration 184 that applies to eight (8) medical professionals. The lead physician (or other authorized individual) has arranged 140 for an initial physician (i.e., Physician 1) to access data concerning a patient. This particular arrangement advantageously requires 158, 160 that Physician 1 access data in the database before access will be permitted by Nurse 1 at 146 or by Physician 2 at 144. (Such access control provides a significant level of security and safety for patient data, and can also be used to safeguard patient health both by ensuring that a proper regimen of treatment or observation is followed and by ensuring that medical personnel are properly supervised.) Access to the database can be limited to a subset of the available patient medical and/or administrative data, and access that is allowed can be limited to “read,” “write,” and/or “update” permission. In addition, more than one “sequence” or “thread” of authorized accesses may be authorized, as illustrated by connections 158 and 160 from block 140 in FIG. 5. If desired, the lead physician (or other authorized individual) can set up the threads so that data accessed or written by individuals in one thread is not available to individuals in another. When it is deemed advantageous to do so, threads that merge or separate can be specified and enforced by DMM 28 controller software. Thus, access by an entity can be conditioned upon prior access by a plurality of other entities whose own accesses are not dependent upon each other's access.

Following the thread represented by arrow 158 in FIG. 5, Physician 2 at 144 is the second person in that thread authorized to access the subject data. After Physician 2 has completed access 162, Nurse 2 is authorized 148 to access data about the patient. As indicated above, Nurse 2 need not necessarily be authorized to access the same data, or all of the same data accessed by Physician 2. After Nurse 2 access the data 168, Lab 1 is authorized 152 to access some or all of the data concerning the patient. In this example, access by Lab 1 also requires that Nurse 1 (at 146) completes access 164 to the data. However, access may be conditioned on more or less complex conditions. For example, either Nurse 1 or Nurse 2 completing access can be sufficient, depending upon the lead physician-specified protocol. Similarly, after Lab 1 has completed access 170, Lab 2 is allowed access. This access may also be conditioned 166 upon completion of access 146 by Nurse 1, so that accesses by both Nurse 1 and Lab 1 are required before access by Lab 2 is allowed, or so that accesses by either Nurse 1 and Lab 1 are required before access by Lab 2 is allowed. After access 172 by Lab 2, Nurse 3 is permitted access 150 to patient data. Finally, after access 174 by Nurse 3, Physician 3 is permitted access 142 to patient data.

Following a second thread in FIG. 5, after access 160 by Physician 1, Nurse 1 is permitted access 146 to patient data. Access to data by Nurse 1 controls access 164, 166 by Lab 1 and/or Lab 2, as described above.

Thus, a method for accessing a patient database is provided that includes defining an access protocol for entities accessing patient data, including at least a first entity having initial access to the patient data; permitting access to the patient data by the at least first entity; and conditioning each further access to the patient data by additional entities upon prior access by at least one predetermined prior entity. In one embodiment, accesses are controlled via a combination of electronic and biometric security.

In one embodiment of the present invention, access control software or firmware in MDMS 58 is used to control access to medical database 136. Thus, either MDMS 58 alone, DMS 28 directly coupled to MDMS 58 and acting as gatekeeper), or both, are used to control access to the medical database in various embodiments of the present invention.

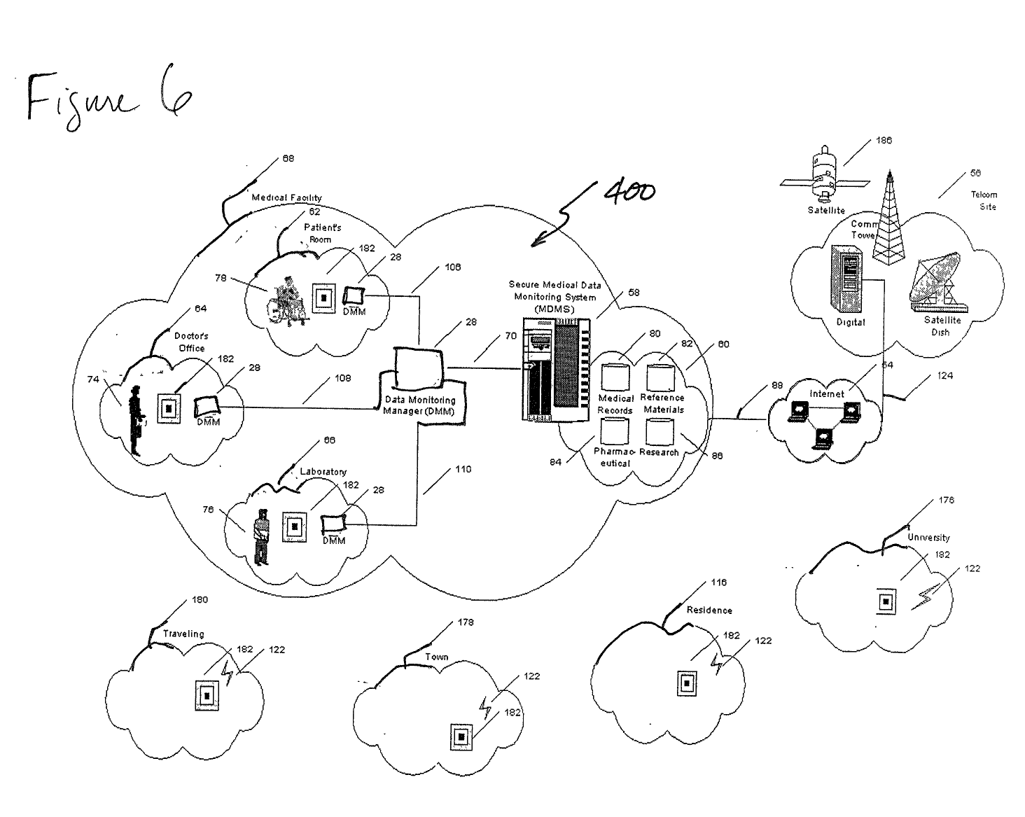

In one embodiment of the present invention and referring to FIG. 6, a bracelet or ID card 182 (represented schematically) containing a microchip or other device capable of being sensed electronically or otherwise capable of identifying an individual communicates via wireless link 122 or with a DMM 28 with an IP network embodiment 400. Thus, it is possible to track patients or medical personnel through a medical facility 68, while traveling 180, in a city 178, at a residence 116, at a university 176, or elsewhere. Communication takes place either within the local network 400 or via a telcom provider 56 or via satellite 186 or other radio communication. In one embodiment, a wide tracking range is provided by the Internet 54 or other network.

In one embodiment of the present invention and referring again to FIG. 1, using PC communicator 10, personnel are linked to a prescription drug order processing system 84 with prescription data and secure patient documentation and health assessment 80. Embodiments of the present invention link pharmaceutical companies 96, health care professionals 90, research centers 92, and medical libraries 94, greatly enhancing dissemination within this subgroup and efficiently relaying secure information.

In another embodiment of the present invention, nursing and medical students as well as ancillary medical personnel have access to one or more electronic library medical databases 60 that distribute textbooks, reference materials 82, periodicals, and medical research 86. The library database is accessed via the Internet 54.

Embodiments of the invention are useful for skilled nursing facilities, linking outside physicians and specialists with faculty, and for utilization within the facility. More particularly, embodiments of the present invention electronically link medical, nursing, residents, fellows, and administrative students with a school's IP materials, general medical references, and periodicals. In another embodiment, patients and other health care consumers utilize a mobile field unit such as PC communicator 10 to electronically access medical information, drug information, for self-monitoring as prescribed by a physician, and for other purposes.

In yet another embodiment of the present invention, PC communicator 10 provides not only dissemination of information, but also computer processing power, intelligent patient medical diagnoses (such as by acting as an automated physicians' advisor), and provides personal digital assistant (PDA) functionality, net access for research, and other functions. Security is provided to facilitate compliance with applicable federal regulations such as HIPPA and any other applicable legal medical record security legislation. Embodiments of the invention are not limited to security required by any specific legislation or regulation, however. Moreover, in one embodiment of the present invention, security is provided for all communication within the network. In this embodiment, the network contains information that integrates various patient and monitoring information, medical reference materials, administrative medical records and pharmaceutical ordering procedures. Collective IP distribution efficiencies provide multiple concurrent or simultaneous input retrieval and transfer.

It will thus be apparent to those skilled in the art that embodiments of the present invention satisfy a number of needs of the medical community. For example, in one embodiment of the present invention, mobile “field” hardware devices are provided for patient monitoring and secure IP database transfer and retrieval. Also, in one embodiment, inpatient and outpatient care assessment and monitoring plurality are provided, including monitoring via patient (or consumer) mobile multipurpose hardware devices. Some embodiments of the present invention provide an ancillary health-care professionals' continuous work-in process database as well as processing networks for the database.

In addition, it will be recognized that embodiments of the present invention are useful for interactive mobile pharmaceutical prescription drug processing systems and medical laboratories database analysis IP database networks, and medical IP networks that include educational and reference medical library databases and skilled nursing/mental health facilities interfacing databases.

From the detailed description herein, it will be appreciated that many embodiments of the present invention provide a seamlessly integrated flow of information is provided that is tightly controlled and digitally restricted to an individual or group of individuals who access, input or record information contained within an IP network system. Information flowing in the network system, in one embodiment, can include medical records, pharmaceutical orders, stationary assessment, cardiorespiratory, and other categories of patient monitoring, “inpatient” room diagnosis, medical library materials, hospital administrative information and other information. The information from these sources is integrated into a seamless mobile environment that is tightly controlled and digitally stipulated to the individual or group of individuals who access, input, or record information that is contained within the embodiment of an IP network.

Also in one embodiment, a medical IP network interfaces a plurality of stationary non-wireless and mobile wireless “field” hardware devices that record information sources, process, transfer, and diagnose the information, including medical records and other content, through the network. This mobile medical system embodiment includes a mobile tablet-size display or other device that displays and processes patient medical records and that functions, when needed, as a diagnosis “field” unit. The mobile medical “field” unit provides medical staff such as nurses and physicians with the ability to receive and diagnose patient information from a variety of stationary, mobile, and continuous devices, and to input subjective observations to patient management. In one embodiment, the present invention provides communication and integrates stationary input to mobile “field” devices, and integrates information including (but not limited to) medical reference library materials accessed in the “field,” pre-established hemodynamic calculations, time-dependent and archived data laboratory data and flow chart data for non-critical and critical patients. Thus, all the information needed by the medical industry can be provided in a seamless IP database configuration.

While the invention has been described in terms of various specific embodiments, it is possible to adapt the invention to other multidisciplinary categories including but not limited to veterinary medicine, oceanography, biology, chemistry, engineering, aeronautical and space industry, geology, archeology and other science-based disciplines. Therefore, those skilled in the art will recognize that the invention can be practiced with modification within the spirit and scope of the claims.

What is claimed is:

1. A hand-held mobile field device configured to provide wireless communication with a plurality of patient medical monitoring devices.

2. The mobile field device of claim 1 further comprising an accessory interface.

3. The mobile field device of claim 2 wherein the accessory interface is configured to provide wireless communication between the mobile field device and fixed inpatient room diagnostic units and continuous monitoring systems in patient rooms.

4. A mobile field device in accordance with claim 1 further configured to provide patient medical diagnoses, personal digital assistant functionality, and net research and access.

5. A network including at least one mobile field device configured to provide communication with a plurality of patient medical monitoring devices, the network being configured to aggregate and to make available to the mobile field unit, a combination of manual, automated, fixed continuous and mobile patient monitoring and assessments.

6. A network including at least one mobile field device configured to provide communication with a plurality of patient medical monitoring devices, and the network electronically connected to databases maintained by a hospital.

7. A network in accordance with claim 6 further comprising at least one electronic medical library database that distributes reference materials including textbooks, reference materials, periodicals, and medical research electronically, and wherein the mobile field device is configured to display the distributed reference materials.

8. A network in accordance with claim 6 used to electronically link medical, nursing, residents, fellows, and administrative students with a school's intellectual property materials, general medical references, and periodicals.

9. A network in accordance with claim 6 in which mobile field devices are used by health care consumers to electronically access medical information, drug information, and for self-monitoring as prescribed by a physician.

10. A network in accordance with claim 6 wherein the databases utilize a plurality of formats and protocols, and wherein security of communication is provided by format-dependent encryption algorithms.

11. A network in accordance with claim 6 configured to consolidate input by physicians, nurses, medical research/clinical personnel, and general medical staff, and to send the consolidated input to a member of the group consisting of administrative information databases, patient account records, insurance companies, hospital medical centers, health care information databases, and combinations thereof.

12. A network including at least one mobile field device configured to provide communication with a plurality of patient medical monitoring devices, the network further comprising a central repository containing medical information and a plurality of subsystem databases linked to the central repository via at least one member of the group consisting of encryption software and secure hardware that tags transmissions and retrievals.

13. A network in accordance with claim 12 linking payment flow information between diagnostic related groups' patient hospital charges and third party insurance providers.

14. A network in accordance with claim 13 wherein security is provided biometrically.

15. A network in accordance with claim 14 wherein the biometric security comprises fingerprint recognition.

16. A network in accordance with claim 12 configured to provide secure patient information electronically on at least one of a local area network (LAN) and a mobile wireless network.

17. A network in accordance with claim 16 configured to disseminate pathology results and medical research to selected individuals.

18. A network including at least one mobile field device configured to provide communication with a plurality of patient medical monitoring devices, the network configured to link a prescription drug order processing system with prescription data and secure patient documentation and health assessment.

19. A network in accordance with claim 18 linking pharmaceutical companies, retailers, wholesalers, physicians, and nurses.

20. A network comprising:
a medical database;
a secure medical database monitoring system communicatively coupled to the medical database; and
a first data monitoring manager communicatively coupled to the secure medical database monitoring system;
wherein at least one of the secure medical database monitoring system and the data monitoring manager is configured to provide controlled electronic access to the medical database by a plurality of entities in accordance with a specification provided by an authorized user.

21. A network in accordance with claim 20 configured to control said electronic access with respect to a patient's data is controlled sequentially, so that at least a first predetermined entity must access the patient's data before a second predetermined entity is permitted access.

22. A network in accordance with claim 21 further configured to selectively control portions of a patient's data, so that each accessing entity has only a predetermined, limited access to preselected portions of a patient's data, the preselected portions varying dependent upon the accessing entity.

23. A network in accordance with claim 22 further configured to provide a plurality of threads of accessing entity sequences.

24. A network in accordance with claim 23 further configured to condition access to a portion of a patient's data upon prior access by more than one different entities.

25. A method for communicating medical data comprising communicating medical data wirelessly to a hand-held mobile field unit from a plurality of patient medical monitoring devices, and communicating the medical data received from the hand-held mobile field unit to a medical database via a secure network.

26. A method in accordance with claim 25 further comprising wirelessly communicating between the mobile field unit and fixed inpatient room diagnostic units and continuous monitoring systems in patient rooms.

27. A method in accordance with claim 25 further comprising aggregating, and making available to the mobile field unit, a combination of manual, automated, fixed continuous and mobile patient monitoring and assessments.

28. A method in accordance with claim 25 further comprising electronically communicating information from databases maintained by a hospital to the mobile field unit.

29. A method in accordance with claim 28 further comprising transmitting encrypted data from the databases to the mobile field unit.

30. A method in accordance with claim 25 further comprising electronically consolidating input from physicians, nurses, medical research/clinical personnel, and general medical staff, and electronically transmitting the consolidated input to a member of the group consisting of administrative information databases, patient account records, insurance companies, hospital medical centers, health care information databases, and combinations thereof.

31. A method in accordance with claim 25 further comprising electronically linking payment flow information between diagnostic related groups' patient hospital charges and third party insurance providers.

32. A method in accordance with claim 31 further comprising providing biometric security for the electronic linking.

33. A method in accordance with claim 32 wherein the biometric security is provided by fingerprint recognition.

34. A method in accordance with claim 25 and further comprising limiting electronic dissemination of pathology results and medical research to selected individuals.

35. A method for controlling access to a medical database comprising:
defining an access protocol for entities accessing patient data, including at least a first entity having initial access to the patient data;
permitting access to the patient data by the at least first entity;
conditioning each further access to the patient data by additional entities upon prior access by at least one predetermined prior entity.

36. A method in accordance with claim 35 further comprising conditioning at least one of the further accesses to the patient data upon prior access by a plurality of predetermined prior entities whose accesses are not dependent upon each other's access.

37. A method in accordance with claim 35 further comprising controlling access to the patient data using biometric and electronic security.
